(19) United States
(12) Patent Application Publication
(10) Pub. No.: US 2014/0115030 A1
(43) Pub. Date: Apr. 24, 2014

(54) INTELLIGENT GLOBAL SERVICES BUS AND SYSTEM FOR MOBILE APPLICATIONS

(71) Applicants: Paul R. Bayliss, Hoboken, NJ (US); Robert A. Cohen, New York, NY (US); Gareth O. Collins, Yonkers, NY (US); Kai Y. Yip, Holmdel, NJ (US); Daniel E. Zeck, Colts Neck, NJ (US)

(72) Inventors: Paul R. Bayliss, Hoboken, NJ (US); Robert A. Cohen, New York, NY (US); Gareth O. Collins, Yonkers, NY (US); Kai Y. Yip, Holmdel, NJ (US); Daniel E. Zeck, Colts Neck, NJ (US)

(21) Appl. No.: 13/655,211

(22) Filed: Oct. 18, 2012

(51) Int. Cl. H04L 29/06

(52) U.S. Cl. CPC H04L 67/42
USPC 709/203

(57) ABSTRACT

A communications system including a plurality of mobile user computing devices, and a service provider subsystem for enabling communications between any of the mobile user computing devices and enterprise network systems. The service provider subsystem has a plurality of clusters strategically distributed across at least one geographical region and interconnected by a global services bus. Each of the clusters includes a plurality of nodes interconnected to a distributed memory storage bus. Each of the nodes includes a service manager module for monitoring services available to the node, a service access point module for enabling communications between the node and enterprise network systems, a client access point module for enabling communications between the node and at least one of the mobile user computing devices, and a message control point module for managing communications between the client access point module and the service access point module.

### CROSS-REFERENCE TO RELATED APPLICATIONS

This application claims the benefit and filing priority of U.S. provisional patent application Ser. No. 61/549,032 filed Oct. 19, 2011, and entitled INTELLIGENT GLOBAL SERVICES BUS FOR MOBILE APPLICATIONS.

### TECHNICAL FIELD

This invention relates to the communications between mobile computing devices and enterprise server computers, and in particular to a global computer network having a multiplicity of nodes arranged in logical clusters that enable such communications, in which the nodes are configured to follow established policies regarding data flows within and across jurisdictional boundaries.

### BACKGROUND OF THE INVENTION

Communications systems, including mobile systems, often are required to be global in scope, that is, to be able to utilize network infrastructures that allow communications across jurisdictional borders. The Internet is a prime example of such global network communications, wherein a user may operate a mobile client device in one country and communicate with a server computer located in another country just as easily as if that server computer were located on the same premises as the client device. In certain situations, however, cross jurisdictional network traffic may be prohibited by the laws of one or more of the jurisdictions involved in the data transfer. For example, a country in Europe may require that when a citizen of that country uses a mobile client device within the borders of that country that communicates with a server computer also located in that country, then all data traffic must be contained within that country; i.e. data may not flow through networks, routers, and/or server computers located outside the territory of that country. This may be done to try to protect the privacy of the citizens of that country by minimizing data flows that are not required to be outside the country. That is, if the mobile client device needs to communicate with a server computer located in another country, then of course the data flows may flow outside the country to carry out the data transaction with that server computer.

Accordingly, there is a need to provide an intelligent mobile applications services bus infrastructure having a multiplicity of nodes that can be configured to allow certain inter-jurisdictional data transfers and deny certain other inter jurisdictional data transfers in accordance with pre-established policies and rules. There is also a need to provide such a network that is adaptive and modular in nature, and that allows for the loss of nodes by providing nodal redundancies, and that allows for addition of nodes that can readily replicate software and applications of other nodes without requiring lengthy and expensive deployment procedures as in the prior art.

Provided herein is a communications system including a plurality of mobile user computing devices, and a service provider subsystem for enabling communications between any of the mobile user computing devices and enterprise network systems. The service provider subsystem has a plurality of clusters strategically distributed across at least one geographical region and interconnected by a global services bus. Each of the clusters includes a plurality of nodes interconnected to a distributed memory storage bus. Each of the nodes includes a service manager module for monitoring services available to the node, a service access point module for enabling communications between the node and enterprise network systems, a client access point module for enabling communications between the node and at least one of the mobile user computing devices, and a message control point module for managing communications between the client access point module and the service access point module.

The distributed memory storage bus in each cluster may include a cluster-wide map of services to the cluster and of capabilities of each available services manager, and the distributed memory storage bus and shares the map with each service manager in the system.

The service manager module may be programmed to monitor the distributed memory storage bus to ascertain availability of other nodes in the system and transfer that information to each client access point for load balancing decisions. The message control points are each programmed with geographical traffic restrictions controlling data flow within the geographical region.

Preferably, information from one node is replicated across other nodes so as not to require a central server.

The mobile user computing devices may interface with the service provider subsystem via a native client, a hybrid client application and/or a standalone web application.

Optionally, each message control point may be programmed to determine the identity of the mobile client device, the application being invoked by that mobile client device, and then determine the appropriate service access point to invoke. Each message control point may be programmed to determine the appropriate service access point to invoke by analyzing an application ID that identifies the application and a user ID that identifies the mobile client device with respect to a set of protocols.

Notably, the system is multi-tenant, enabling the same client to interconnect through the service provider cloud to multiple enterprise servers simultaneously.

Each of the mobile user computing devices executes an application that declares the services it desires. Moreover, each of the mobile user computing devices is enabled to make a services request asynchronously, wherein the device may be at a different node when the server tries to respond.

Optionally, the service provider subsystem is enabled to analyze the mobile user computing device requirements and service capabilities and determines how to connect the mobile user computing devices to available enterprise services.

### BRIEF DESCRIPTION OF THE DRAWINGS

FIG. 1 is an illustration of the network topology including several distributed clusters.

FIG. 2 is an illustration of the topology of each network cluster of FIG. 1.

FIG. 3 is an illustration of architecture of each node in the cluster of FIG. 2.

FIG. 4 is a data flow diagram of the multi tenant native or standalone web, authentication required, process.

FIG. 5 is a data flow diagram of the multi-tenant hybrid client, authentication required, process.

FIG. 6 is a data flow diagram of the service-directed (store & forward required) process.

FIG. 7 is a data flow diagram of the client-directed store7 forward (device online) process.

FIG. 8 is a block diagram of a dual node GSB (GLOBAL SERVICES BUS) cluster.

FIG. 9 is a block diagram of message control point examples.

FIG. 10 is an alternative block diagram illustration of the system of the present invention.

### DETAILED DESCRIPTION OF THE PREFERRED EMBODIMENT

The following terms are used throughout this specification and defined as:
Apache Cassandra—highly-scalable and highly-available database with in-memory and disk persistence, designed for sharing data across multiple data centers (we use Cassandra for store and forward and other persistent data)
Apache ActiveMQ—a popular JMS 1.1 message broker, with support for many advanced features, released under Apache 2.0 license
CAP—Client Access Point, the interface between the client/device application and the bus
GSB application—comprised of (1) client app, (2) an MCP, (3) backend adapter(s) and (4) SAP service configurations
Hazelcast—high-performance, in-memory data distribution and clustering solution for java using TCP/IP and optional multicast node discovery (we use this for sharing session state, service state and jmx related info)
JMS—Java Message Service, an API managed within the java community (JSR 914). In GSB, the message bus is based on JMS API.
JMX—Java Management Extensions, used to configure and gather status and health info for software elements in the GSB
LDAP—Lightweight Directory Access Protocol
MCP—Message Control Point, the bus element that provides the logic (SCXML/javascript) for handling messages between clients and services (uses SCXML for state-control decisions message routing and optional javascript for logic)
OSGi—Open Services Gateway initiative, a module/component model for java, OSGi “bundles” are used to deploy, start/stop and update applications and services in GSB
SAP—Service Access Point, the interface between services and the bus
SCXML—State Chart XML, used in the MCP, along with optional javascript, to manage the state of message flows between client applications and services
Service—a backend that provides ERP, CRM, EAM etc. data (e.g. Siebel), shared AMP GSB offering (e.g. Storage, Bing Maps) or partner functionality (e.g. Network provider location API) to a client application
Service Management—the bus software component that enforces privacy policy and coordinates communications between Client applications, MCPs and Services.
TTL—Time to live, applicable in our case to store and forward data sets

Provided is a global computer network having a multiplicity of nodes that communicate with deployed mobile client devices and which are arranged in logical clusters and geographically distributed throughout the jurisdictions of interest. The present invention provides for a flexible approach in order to attain the desired data routing, traffic support, nodal redundancies and software replication across the nodes.

In prior art systems, large data centers are used to enable enterprise server computer systems to communicate with mobile devices deployed in the field. This topology is now divided into in-country access points that can be distributed and enabled/disabled in a dynamic and robust fashion, and managed appropriately.

In the present system, mobile client devices connect to local access points in the country of interest. Applications executing on the client device will declare the services that it needs to the cloud which is defined further below. Services that interconnect with the cloud also declare what their capabilities are. Then, the cloud determines how to connect that application to the correct back end (enterprise) service.

In this system, wherein nodes are separated by geographical boundaries, an event that may happen on one side of the world with a particular server may be propagated in a meaningful way across to the rest of the network. By way of example, if a particular service is being used by client devices on 50% of the nodes, the other 50% have no need to understand the specifics (such as data load and capacity) of this particular service. However, if a client device connects to one of those servers, then from that point on it will be notified of the particular service parameters.

In regular web connections, a client device makes a request and gets a response in the same session. In the present system, the device may make a request asynchronously; wherein the device may be at a different node when the server tries to respond.

With current (prior art) systems, if a government wishes to deploy a system for use in its country, the entire infrastructure in use today (as described for example in detail in U.S. application Ser. No. 12/822,844 entitled System & Methods for Developing, Provisioning & Administering Composite Mobile Applications Communicating in Real-Time With Enterprise Computing Platforms, which is owned by the assignee of the present application and incorporated by reference herein) must be deployed entirely within that country, which is a prohibitively expensive and time-consuming task to implement and service. Under the present invention, however, a single server computer may be located within the desired jurisdiction and interconnected across a message bus (referred to as the Global Services Bus and described further herein).

### Distributed Clusters

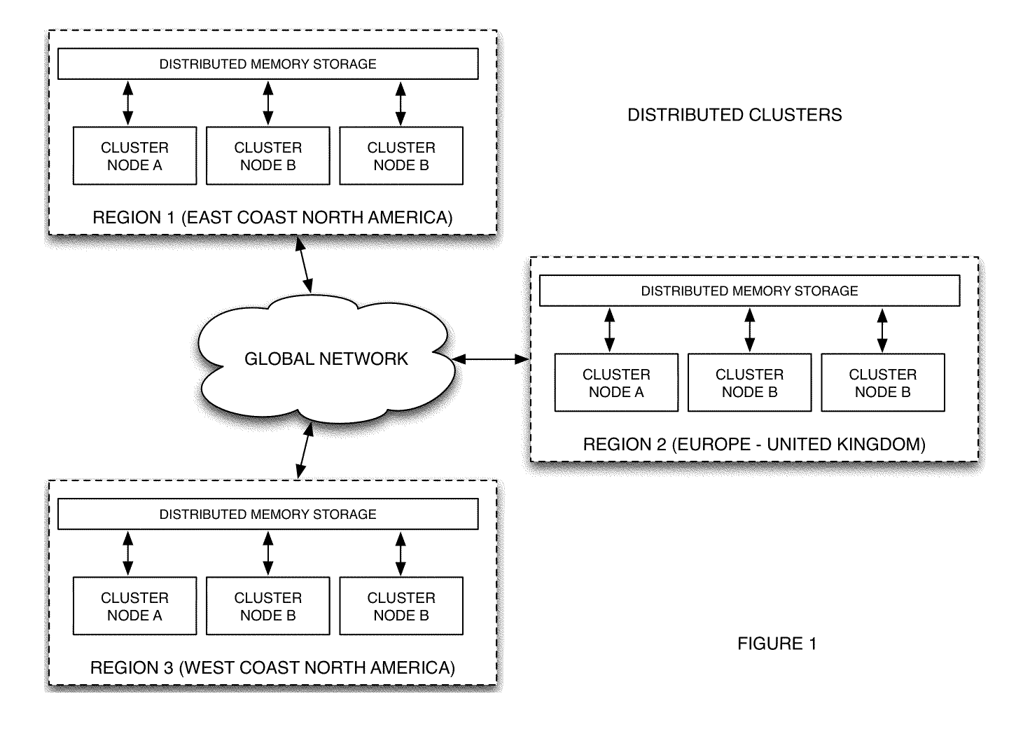

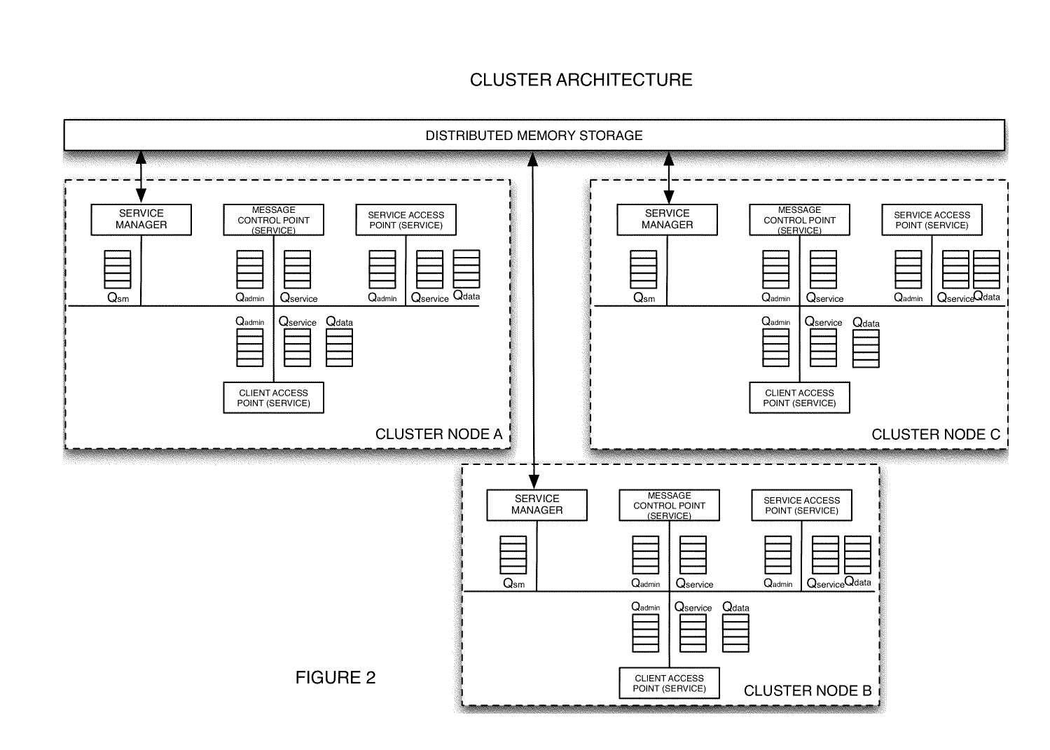

The overall system consists of several clusters that are distributed within each geographic region or jurisdiction of interest. The clusters interconnect with each other as shown by the common cloud notation in FIG. 1. Each distributed cluster will be comprised of several cluster nodes, shown in FIG. 1 as cluster node A, cluster node B, cluster node C, etc. All of the cluster nodes within a given cluster are interconnected with each other via a “memory storage bus” as shown in FIG. 1, and which will be described in further detail herein. FIG. 2 illustrates the architecture of each cluster that makes up the entire system of FIG. 1.

A service may include external services and internal services. An external service may be thought of a connection, or a collection of connections, from the mobile client device to a back end host computing system, which is handled by the system of the present invention. The connections may include data being processed by an application that executes on the mobile client device in concert with the back-end host computing system in order to execute a desired task or series of tasks. An internal service may include for example a node on the broker or bus that does something useful internally such as tracking connectivity of a mobile client device, or for example an instant messaging service that monitors incoming messages and chats, controls those chats, etc. This may occur on a single node or be distributed across multiple nodes, in which case the state may be held in more than one place and distributed accordingly.

### Multi-Tenant

The system is multi-tenant in nature, whereby data traffic in and out of a host computer or computers operated one entity or customer can coexist with that of a second entity or customer without intermingling. For example, a mobile client device may have a consumer application (“app”) that interconnects via the present invention with a host computer operated by a stock trading company whereby the user can use the app to trade stocks as desired via a system interconnection with the stock trading host computer, and the same mobile client device may have a business application (“app”) that interconnects via the present invention with a host computer operated by the user's employer whereby the user can use the app to send and receive data as desired via the same (or a different) system interconnection with the employer's host computer.

### Cluster Nodes

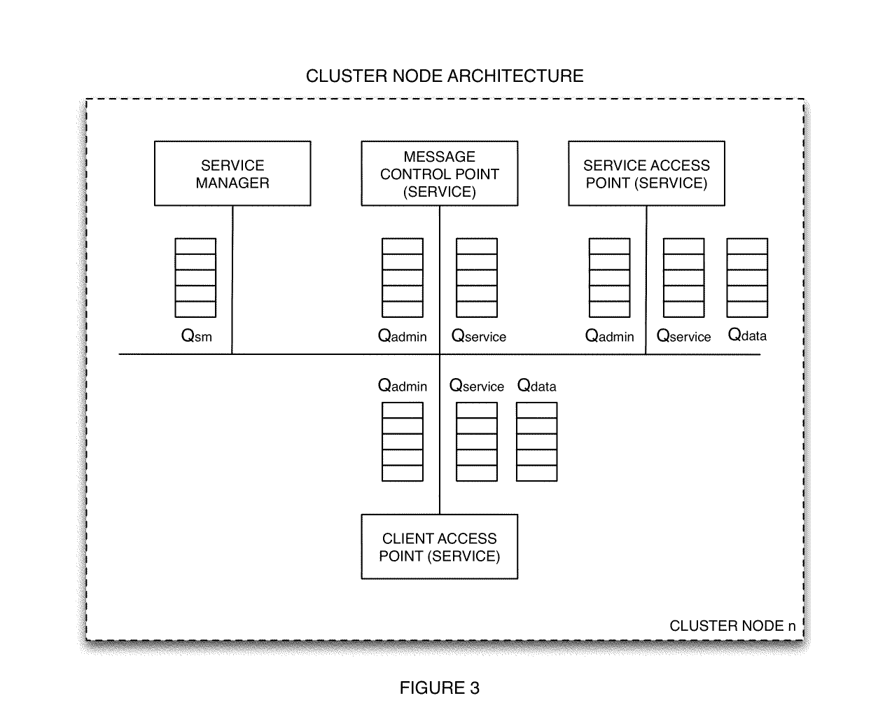

As shown in FIGS. 1 and 2, each cluster in the system is comprised of a series of cluster nodes, the details of which are shown in FIG. 3. Each cluster resides on its own instance of the message broker so that data messages can flow back and forth between the various nodes on the cluster.

The main subsystems of each cluster node are the client access points, the service manager, the message control point, and the service access point, all of which are interconnected by an internal bus as shown. Each node is capable of measuring its data traffic and triggering the intelligent services bus to scale up or down in order to efficiently handle traffic loads when a particular node is overloaded. Traffic can be re-routed, balanced or peer nodes can be deployed to take up load that exceeds a particular node's traffic capacity.

Mobile client devices will communicate with the system via the client access points as shown in FIG. 3.

Back-office or host computing systems will interconnect with the system via the service access point as shown in FIG. 3.

### Message Control Point

The message control point manages data traffic between a client access point for a given mobile client device and the required service access point as determined by the message control point protocols. After a mobile client device connects to a client access point, the message control point will determine the identity of the mobile client device, the application being invoked by that mobile client device, and determines the appropriate service access point to invoke. The data traffic will contain an application ID that identifies the application and a user ID that identifies the mobile client device. The message control point for example may determine that the data request has come from a mobile client device registered with Customer A, and then send that traffic to the Customer A's service access point, which will contain more specific functionality as to how to handle the application that is being invoked as designated by the application ID.

State Chart XML is implemented in the message control point, which is a mechanism for defining the mechanism of state engines using XML. Using this a developer is able to outline what an application does in terms of standards based declarative language to determine what to do in specific situations.

The message control point therefore is able to make decisions on how to send messages, receive messages, process messages based on the content of those messages, and provide application functionality. For example, a field service representative may be using a mobile client device and be sent a ticket to act upon, and if he hasn't responded within a predefined time period (e.g. 30 minutes), then the message control point will determine the next step to take such as forwarding a message to the field service representative's manager for further action.

### Service Manager

Each node within a cluster has a service manager which is responsible for monitoring all of the services on that broker (bus). The service manager translates service IDs into absolute locations of services.

Referring again to FIG. 2, the Distributed Memory Storage maintains a cluster-wide map of what is available on the cluster. For example, if a particular service is unavailable in cluster node A, the service manager identifies the service loss on the local broker and pushes that information across the Distributed Memory Storage to the service managers on the other cluster nodes in the cluster (B, C). Likewise, the capabilities and capacities of each service manager is shared with all other service managers in the cluster via the Distributed Memory Storage, such as if the service manager in cluster node B can handle a large amount of traffic then the service managers in cluster nodes A and C will be provided with that information and make use of it accordingly. This enables optimal use of the various nodes in the event of load variations across the nodes in a cluster, node outages, etc.

In addition to each service manager managing its own broker and the services that are attached to the service manager as well as capacity and load issues, each service manager will also monitor the Distributed Memory Storage to ascertain if another cluster node becomes unavailable. That loading and capacity information may then be passed down to each client access point in order to make intelligent routing decisions and promote load balancing amongst the various available cluster nodes. For example, the messaging control point in node A may elect to inform its client access point to forward all traffic to the client access point in node C.

In the system, there is one service manager assigned to each message broker, which monitors the local nodes. All service managers maintain global cluster service status. Distributed Memory Storage allows individual service managers to contribute to the cluster's service availability. Each service manager contributes the status of its own services to the shared status memory. The first service manager to start is designated as the active service manager, and the service managers each monitor the state of at least one other service manager in the cluster. If the active service manager terminates (or is deemed faulty), then the remaining service managers elect a new active service manager (e.g. the service manager with the greatest uptime to start with for simplicity). The new active service manager updates the service availability and decrements all of the affected services in the cluster node for the defunct service manager.

The re-routing of data traffic in accordance with current capacities and load balancing parameters as well as service availabilities amongst the cluster nodes is tempered by the rules and regulations that dictate if certain data traffic must remain within the geographic boundaries of a given country or region. For example, if a user of a particular mobile client device is a German national citizen and the services being used are consumer-oriented, then requirements may be imposed that would disallow re-routing of data from that device to a node or cluster that may be located outside of Germany. If, however, the user is not a German national citizen, or if the services being used are business-oriented rather than consumer-oriented, then those requirements may be ignored and re-routing of data from that device to a node or cluster located outside of Germany may be permissible.

As such, a message control point may be programmed with geographical or other jurisdictional restrictions. For example a message control point may be programmed to not allow traffic from certain jurisdictions, such as if traffic from a United Kingdom client device makes its way to a node in the United States, the message control point in the United States' nodes may be programmed to disallow processing from that UK device, raise a flag for an alarm condition, etc.

Data traffic routing therefore uses knowledge about the network (loading, capacity and bandwidth, etc), knowledge about the apps requesting services, knowledge about where the services are, knowledge about the users (identified by the mobile client device), knowledge about the nodes. This intelligence is replicated amongst the various nodes and clusters through use of the Distributed Memory Storage so that a central server is not required in order to manage the intelligence and data traffic parameters.

Transaction logs are kept on each data transaction to provide evidence of compliance with local laws regarding data routing as described above.

### Service IDs

Referring again to FIG. 3, an admin queue (Qadmin) for each node is unique within the system. Service IDs are assigned to each service across all cluster nodes. Within a cluster, each service ID maps to a single queue name. Services across distributed clusters will have a unique queue name per cluster.

### Data Flows

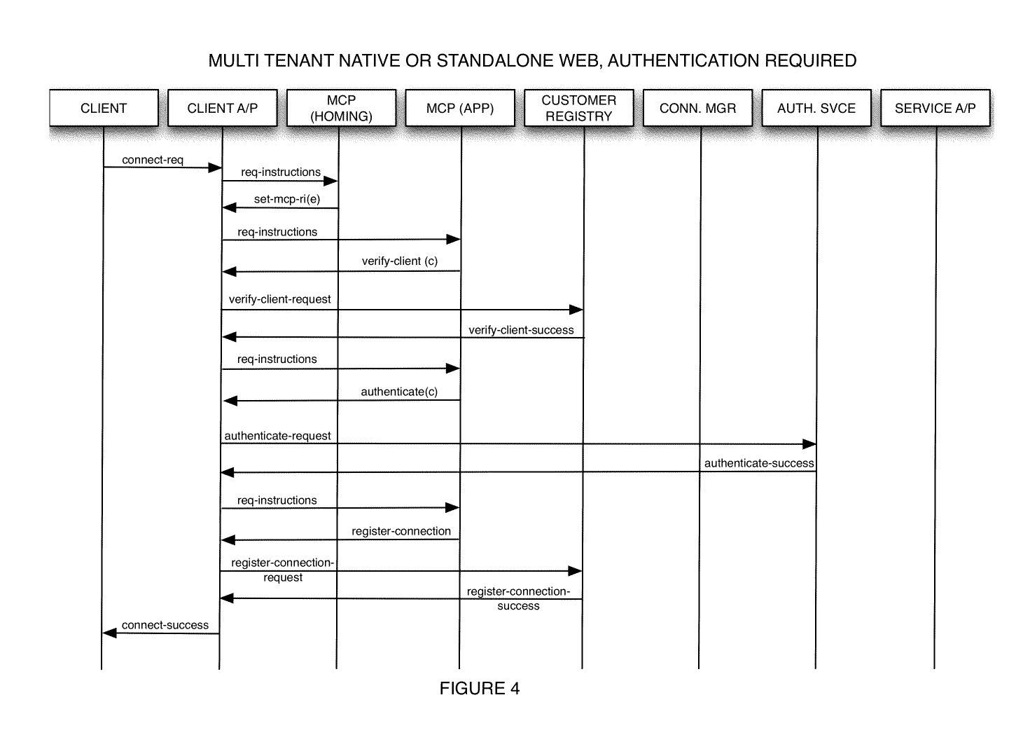

FIG. 4 is a data flow diagram shown in ladder format that illustrates a multi-tenant native or standalone-web, authentication required message flow as follows. First a mobile client device sends a connection-request message to a client access point, and the client access point sends a request-instructions message to its message control point. In this case, the message control point tells the client access point to set a different message control point by returning a set-mcp-ri(e) message to the client access point. This new message control point is designated MCP (App) and is specific to the requested application. The client access point does not send the entire message to its message control point, rather it sends a small header (e.g. around 5K) that has the information required for the message control point to make a routing decision.

Next, the access control point sends a verify-client-c message to the MCP (App) to confirm that this customer exists for this application. Assuming this to be true, then the MCP (App) returns an appropriate response. Next, the access control point interacts with the customer registry to verify-client-request, and a verify-client-success message is returned from the customer registry. The access control point then sends a request-instructions message to the MCP (App), which returns an authenticate-c message. An authenticate-request message is sent to the authentication service, which returns an authenticate-success massage. A request-instructions message is then sent to the MCP (App) which returns a register-connection message. A register-connection-request is sent to the connection manager, which returns a register-connection-success message to the access control point. The access control point then sends a connect-success message back to the mobile client device to finish the authentication process.

This process is useful in enabling the store and forward data flow in which data intended for a certain client is held at the node until the client reconnects, at which time the stored data is then forwarded to the client by the node.

### Application Profile

An application profile contains the policies governing inter-jurisdictional data transfer laws, rules about the application, and rules about the services required by the application profile.

### Multi-Tenant Hybrid Client, Authentication Required

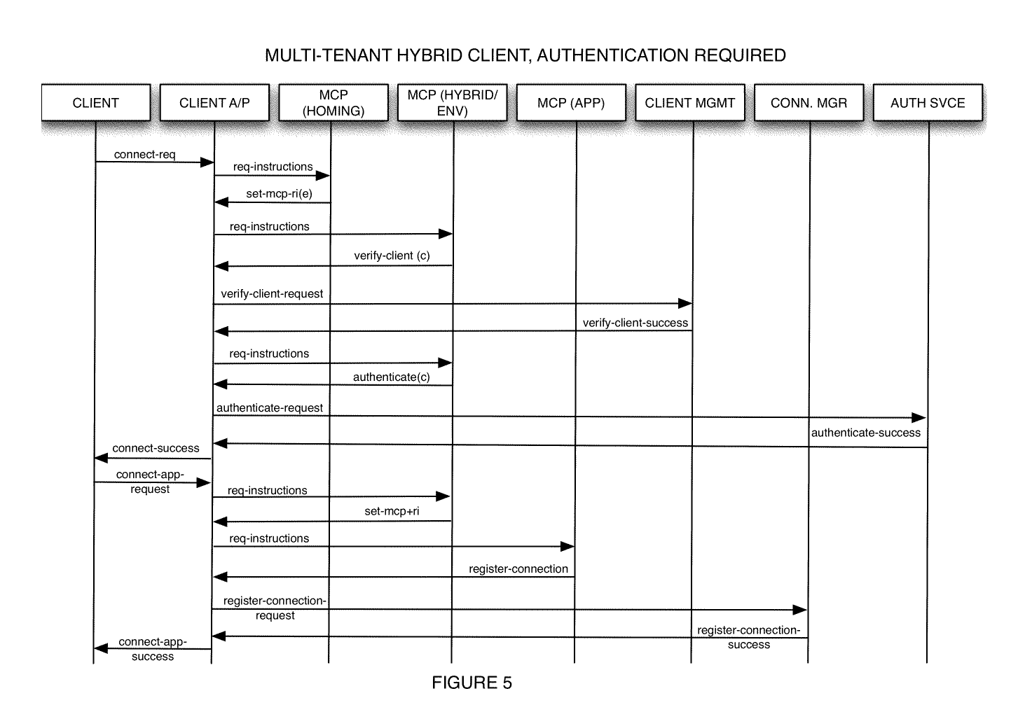

Reference is now made to the data flow diagram shown in ladder format in FIG. 5. In this data flow, the hybrid client acts as an application container, which holds one or more web applications. In the case of a hybrid client, there is a need for another message control point (shown in the diagram as MCP (hybrid/Env). This will recognize the hybrid client application and that the hybrid client may run several sub-applications, and will recognize which sub-application is being executed on the mobile client device.

### Store and Forward

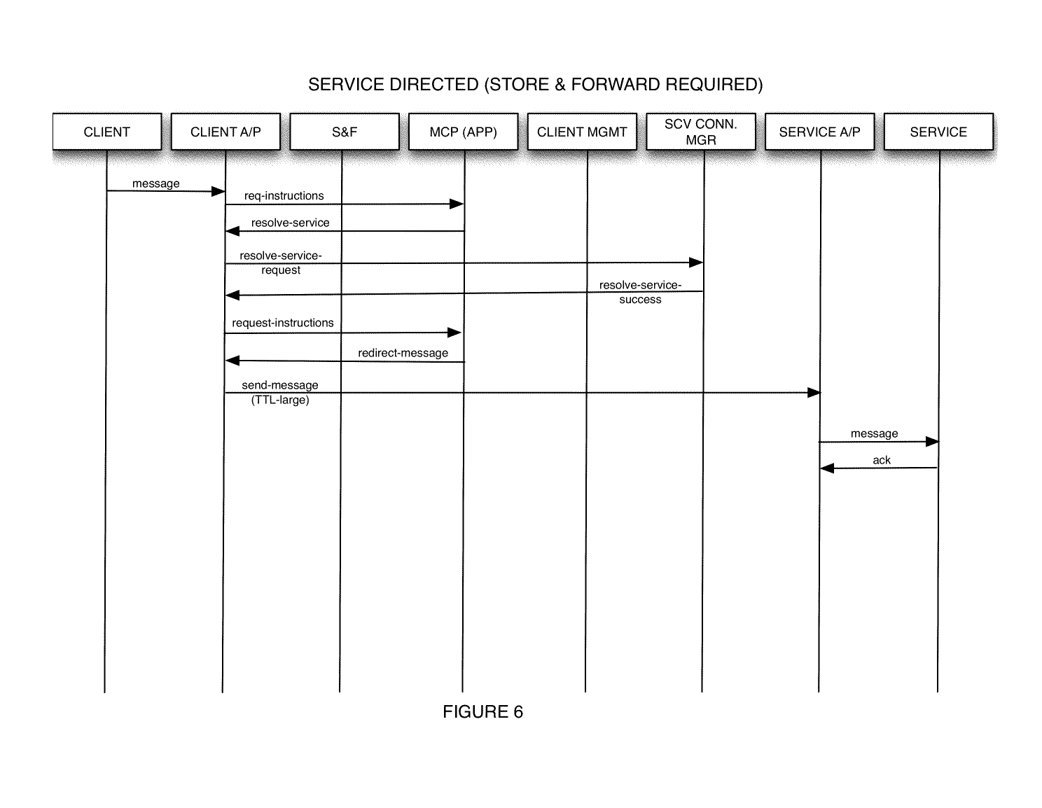

Reference is now made to the data flow diagram shown in ladder format in FIG. 6 for service-directed store and forward. The mobile client device sends a message to the access control point, which will send a request-instructions message to the message control point MCP (App). The MCP (App) returns a resolve-service message to the access control point, which in turn then sends a resolve-service-request message to the service connection manager. The service connection manager returns a resolve-service-success message, and the access control point sends out a request-instructions message to the message control point MCP (App). The MCP (App) returns a redirect-message to the access control point, which sends a send-message (TTL:large) message to the service access point. The service access point will then send a message to the service, which acknowledges with an ack message.

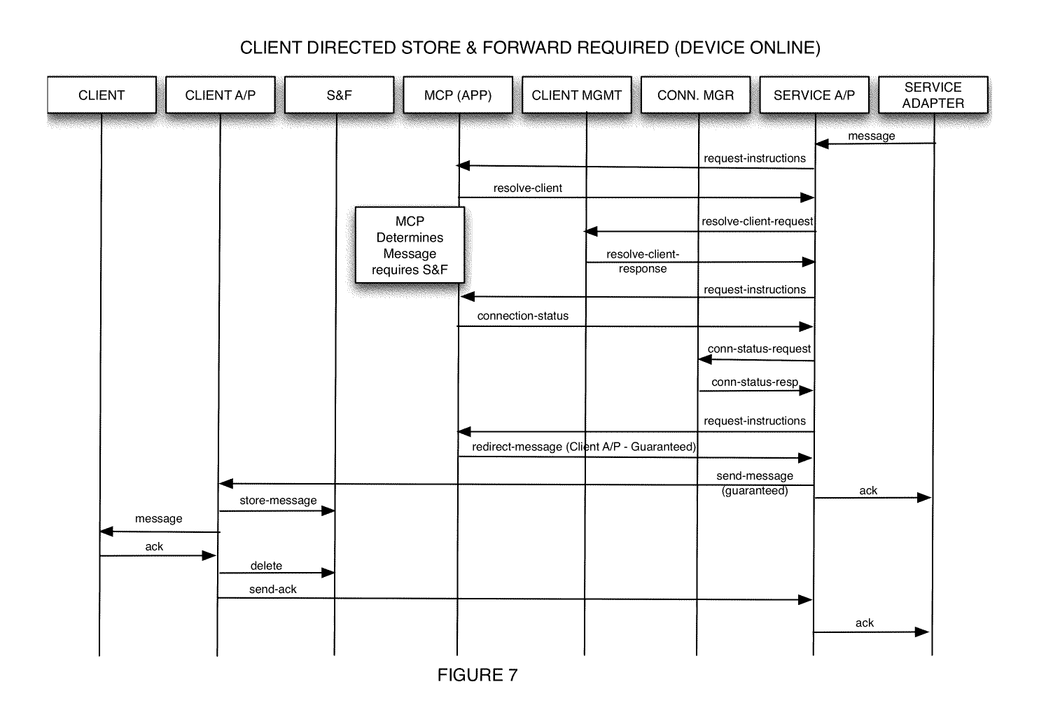

Reference is now made to the data flow diagram shown in ladder format in FIG. 7 for client-directed store and forward. Java Messaging Service (JMS) is used in the preferred embodiment, thus obviating the need to design a store and forward mechanism from the ground up. Here, the general requirements are to store the message as close to the cluster node as possible in order to minimize the hops required for transmission. Also, the message is only stored if it is absolutely required to be stored, but it is still guaranteed that the message will be delivered. In the example of FIG. 7, the mobile client is online, the message is sent to the client device and stored at the same time. Once the message is returned from the client, it is automatically deleted from the storage. If the message is not acknowledged as being received at the client, then the message is not deleted from the storage. Notably, as the client moves amongst various nodes, the message storage for that client moves along with it in a dynamic fashion, rather than being permanently located at one node as in the prior art.

OSGi—Open Services Gateway initiative

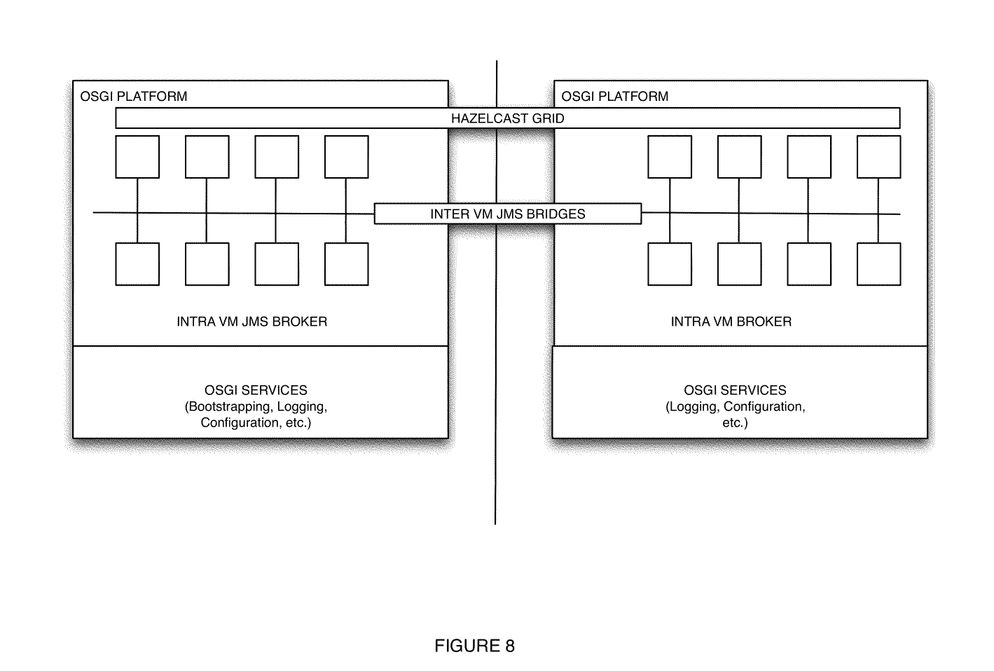

For purposes of a teaching example, FIG. 8 illustrates a dual node cluster, although clusters of course are not limited to just two nodes. FIG. 8 illustrates two nodes, each running an instance of an OSGi platform and interconnected with each other by a clustered memory grid. The OSGi (Open Services Gateway initiative) framework is a module system and service platform for the Java programming language that implements a complete and dynamic component model, something that as of 2011 does not exist in standalone Java/VM environments. Applications or components (coming in the form of bundles for deployment) can be remotely installed, started, stopped, updated and uninstalled without requiring a reboot; management of Java packages/classes is specified in great detail. Application life cycle management (start, stop, install, etc.) is done via APIs that allow for remote downloading of management policies. The service registry allows bundles to detect the addition of new services, or the removal of services, and adapt accordingly.

The clustered memory grid is an open source clustering and highly scalable data distribution platform for Java. JVMs that are running the clustered memory grid will dynamically cluster and allow sharing and partitioning across the cluster. This clustered memory grid is a peer-to-peer solution (there is no master node, every node is a peer) so there is no single point of failure.

Thus, the clustered memory grid comprises a clustering shared memory schema, wherein several physical machines can host a cluster instance, and when data is written into that instance it is if it has been written across the multiple machines. Every machine that is connected to the clustered shared memory can access the data that was written by the first one. So, when a device connects to one node, then every other node is aware of that, regardless of where the messages come from (which node they enter), the system can easily communicate with whichever node the device is connected to. This maintains the context of where a particular client is connected into the system.

As a result, installation of software (or reconfiguration) onto one node propagates onto all nodes immediately.

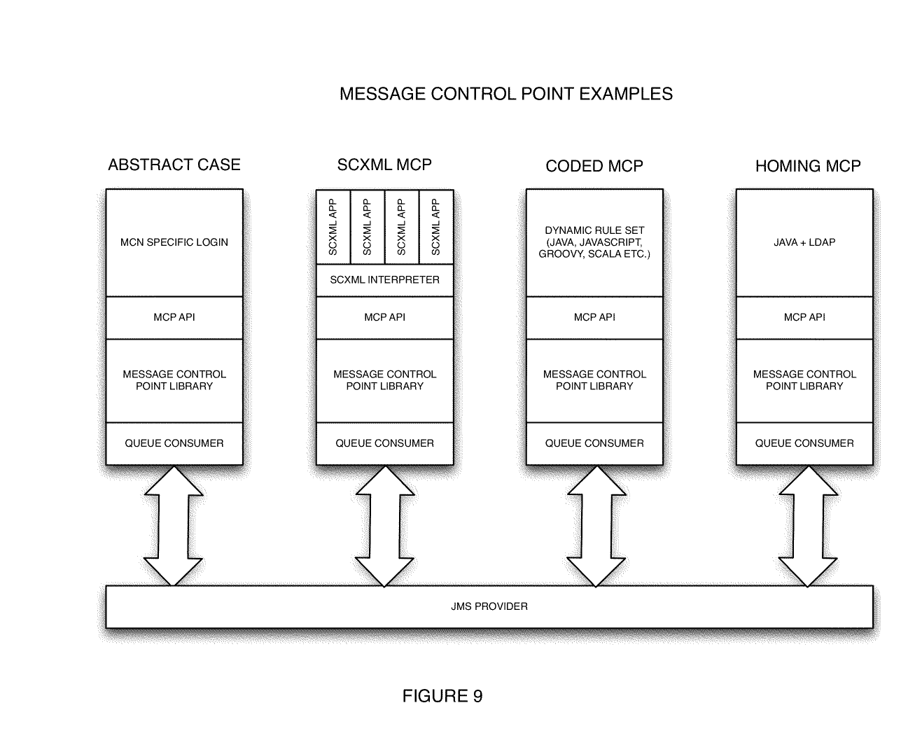

Reference is now made to FIG. 9—Message Control Point examples. The Homing Message Control Point provides functionality to resolve to further MCPs based on the user and application connecting to the bus. Typically on receipt of a connect indication from a device, the Homing MCP would instruct the client access point to set a different, more application specific, MCP for all future messages pertaining to that connection. The Homing MCP would make the decision of which MCP to transfer control too based on a persistent data store such as LDAP.

The SCXML Message Control Point supports the W3C State Chart XML standard (http://www.w3.org/Tr/scxml) and would be used for application level messaging control. For example, a field service application may have a SCXML to send a ticket to a field service engineer, but also to track that the FSE received the ticket, viewed it and accepted it. If this didn't happen, the SCXML rules may do things like escalate the ticket to a manager etc. (A little background on SCXML—It evolved from CCXML (Call Control XML) and VoiceXML, so it's use in mobile data routing and application logic is somewhat novel.)

The Coded Message Control Point would be used for high performance applications. For example, instead of the application logic being interpreted at runtime it would be coded in, say, Java to be as efficient as possible.

Abstract Case of the MCP essentially illustrates that the lower layers of the MCP can support a number of higher implementations as described above.

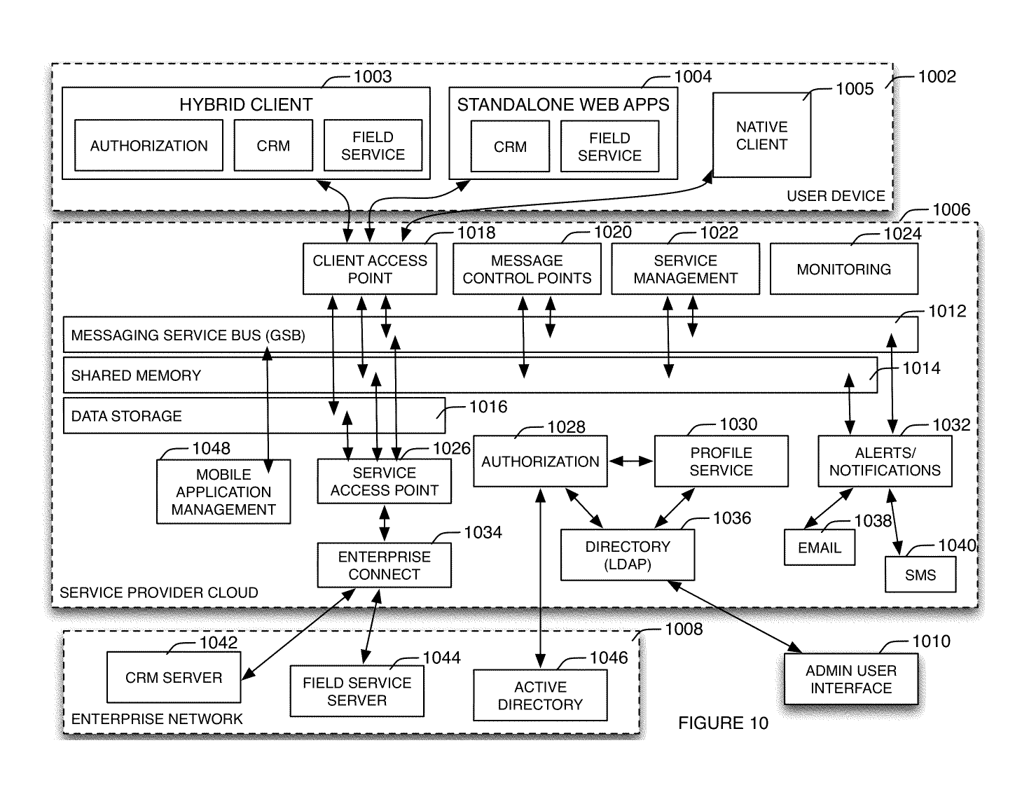

FIG. 10 is an alternative block diagram illustration of the system of the present invention. As shown in FIG. 10, the three main components of the system are a user device 1002, a service provider cloud 1006, and an enterprise network 1008. In practical application there will exist a multiplicity of user devices 1002 but only one is shown here for sake of clarity. The service provider cloud 1006 is a logical subsystem that includes a variety of hardware and software components as will be described further herein. The enterprise network 1008 includes various pre-existing enterprise (also referred to as legacy) systems that with which the service provider cloud 1006 will interoperate to facilitate communications with the various user devices 1002 as will be described. There may be a number of enterprise networks 1008 although only one is shown in FIG. 10 for sake of clarity.

A user device 1002 is typically a handheld computing device with wireless Internet access capabilities as well known in the art, for example a IPHONE or ANDROID based smartphone, or other similar device that provides user input such as a touchscreen or other buttons and switches, user output such as a display and speaker, computing/processing capabilities, program storage, and wireless network access. The user device 1002 may also be a desktop computer having a wired Internet connection although the wireless handheld embodiment provides greater flexibility to the user.

The user device 1002 may operate in either of three modes; a native client mode, a hybrid client mode and/or a standalone web app mode. The hybrid client 1003 is an application that operates on the user device 1003 as known in the art, for example an IOS application that provides dedicated functionality as will be described. The standalone web app 1004 operates in a similar manner but within a web browser such as SAFARI, and provides similar functionality to the user as does the hybrid client 1003 except where noted herein.

The hybrid client 1003 is adapted to run an authorization module, a CRM (customer relationship management) module, and a field service module, all of which present various functionalities to the user as will be described. The authentication module will prompt the user to input his login credentials (e.g. name and password).

The various modules/applications that operate on the user device will interconnect with a single client access point (CAP) 1018 that is part of the service provider cloud 1006. The client access point 1018 will format the messages from the user device 1002 to a format that is understood by the messaging service bus 1012, which may be for example a Java messaging service (JMS) bus or the like. In the alternative to using JMS, the messaging service bus may utilize Advanced Message Queuing Protocol (AMQP).

Shared memory 1014 may be implemented by using HAZELCAST, which is an open source clustering and highly scalable data distribution platform for Java. The shared memory 1014 allows many software components to share state about relevant events happening with respect to the messaging service bus 1012. For example, the shared memory 1014 is aware when an application is connecting, when users are present, when services are present, etc.

The data storage 106 may be implemented for example by CASSANDRA, which is a store and forward service that stores data and provides a time-to-live (TTL) parameter. CASSANDRA is an open source distributed database management system designed to handle very large amounts of data spread out across many commodity servers while providing a highly available service with no single point of failure.

The service provider cloud also has a number of message control points (MCPs) 1020. Each application will have a message control point 1020. For example, there will be a CRM MCP and a Field Service MCP.

Service management 1022 is a subsystem that manages the availability of services and enables the various connections that may be required. Service management 1022 determines if a user that requests a particular service is authorized to use that service (e.g. has that service been paid for that user).

Monitoring console 1024 may be a JMX console such as NAGIOS. All of the subsystems herein have JMX capabilities and generate Java Management Extensions (JMX) messages that are collected, aggregated and displayed to a system operator via the monitoring console 1024. This provides a system operator with information on the bus status and the like.

Authorization services module 1028 interoperates with profile service module 1030 and the directory module 1036 to provide authorization services. User authentication may take place with respect to an enterprise directory (active directory 1046 of the enterprise network 1008), or it may take place with respect to a user directory 1036 that resides in the service provider cloud 1006 and runs on LDAP (lightweight directory access protocol). The profile service 1030 is integrated with this process, and also provides for enabling certain applications to get downloaded to the user device 1002. The directory 1036 is also a repository that governs configuration of the messaging service bus 1012.

Alerts service module 1032 is triggered by any of the elements, primarily by the MCP 1020. This may be extended by interfacing with a notification service that already exists on the user device 1002, such as the Apple Notification service for IOS devices and the Google Notification Service for ANDROID devices. For example, when certain predefined events occur within the service provider cloud 1006, then en email 1038 and/or an SMS (short messaging service) text message 1040 may be delivered to one or more persons to alert them of the event that has occurred (for example, lost messages, timed out messages, etc.).

The CRM and filed service applications in the hybrid client 1003 or the standalone web app 1004 on the user device 1002 are for example HTML5 code that communicate via Javascript to the client access point 1018, which in turn communicates with the CRM server 1042 and/or the field service server 1044 in the enterprise network, as the case may be.

Also shown in FIG. 10 is a native client 1005 that may execute on a user device 1002.

Third party services from third parties such as ATT and VERIZON may be integrated into the system of FIG. 10. For example, a third party speech-to-text translation service offered by a third party may be integrated in a seamless manner so the user can gain access to these services while operating the hybrid client 1003 or standalone web app 1004. In this case, the service management module 1022 enables such integration. For example, a Verizon phone may attempt to implement a service offered by AT&T to its customers, so in that case the service management module 1022 may recognize this and disallow such usage. A set of rules may be established and stored with the service management module to enable it to act upon messages in this manner.

The service access point 1026 and enterprise connect module 1034 together are the interface or demarcation between the service provider cloud and the enterprise network 1008. That is, the service access point 1026 and enterprise connect 1034 provide the conduit for data flows to and from the enterprise network 1008.

Mobile application management (MAM) service 1048 provides for application installation and management over the air (wirelessly) on a mobile user device 1002. This allows systems on in communication with the messaging service bus 1012 to communicate with the mobile devices 1002.

What is claimed is:

1. A communications system comprising:
a plurality of mobile user computing devices, and
a service provider subsystem for enabling communications between any of the mobile user computing devices and enterprise network systems, the service provider subsystem comprising:
a plurality of clusters strategically distributed across at least one geographical region and interconnected by a global services bus, each of said clusters comprising:
a plurality of nodes interconnected to a distributed memory storage bus, each of said nodes comprising, operatively interconnected with each other:
a service manager module for monitoring services available to the node,
a service access point module for enabling communications between the node and enterprise network systems,
a client access point module for enabling communications between the node and at least one of the mobile user computing devices, and
a message control point module for managing communications between the client access point module and the service access point module.

2. The communications system of claim 1 wherein the distributed memory storage bus in each cluster comprises a cluster-wide map of services to the cluster.

3. The communications system of claim 1 wherein the distributed memory storage bus in each cluster comprises a cluster-wide map of capabilities of each available services manager and shares the map with each service manager in the system.

4. The communications system of claim 1 wherein the service manager module is programmed to monitor the distributed memory storage bus to ascertain availability of other nodes in the system and transfer that information to each client access point for load balancing decisions.

5. The communications system of claim 1 wherein the message control points are each programmed with geographical traffic restrictions controlling data flow within the geographical region.

6. The communications system of claim 1 wherein information from one node is replicated across other nodes so as not to require a central server.

7. The communications system of claim 1 wherein the mobile user computing devices each interface with the service provider subsystem via a hybrid client application.

8. The communications system of claim 1 wherein the mobile user computing devices each interface with the service provider subsystem via a standalone web application.

9. The communications system of claim 1 wherein each message control point is programmed to determine the identity of the mobile client device, the application being invoked by that mobile client device, and determines the appropriate service access point to invoke.

10. The communications system of claim 9 wherein the message control point is programmed to determine the appropriate service access point to invoke by analyzing an application ID that identifies the application and a user ID that identifies the mobile client device with respect to a set of protocols.

11. The communications system of claim 1 wherein the system is multi-tenant, enabling the same client to interconnect through the service provider cloud to multiple enterprise servers simultaneously.

12. The communications system of claim 1 wherein each of the mobile user computing devices executes an application that declares the services it desires.

13. The communications system of claim 1 wherein each of the mobile user computing devices is enabled to make a services request asynchronously, wherein the device may be at a different node when the server tries to respond.

14. The communications system of claim 1 wherein the service provider subsystem is enabled to analyze the mobile user computing device requirements and service capabilities and determines how to connect the mobile user computing devices to available enterprise services.
